(19) United States
(12) Patent Application Publication
(10) Pub. No.: US 2005/0166546 A1
(43) Pub. Date: Aug. 4, 2005

(54) Spacer for insulating glazing units

(76) Inventor: Gerhard Reichert, New Philadelphia, OH (US)

Correspondence Address: Zollinger & Burleson, Ltd., P.O. Box 2368, North Canton, OH, 44720, US

(21) Appl. No.: 11/027,664

(22) Filed: Dec. 30, 2004

Related U.S. Application Data
(62) Division of application No. 10/613,256, filed on Jul. 3, 2003.
(60) Provisional application No. 60/393,593, filed on Jul. 3, 2002.

(51) Int. Cl. E06B 3/70

(52) U.S. Cl. 52/786.13

(57) ABSTRACT

An insulating spacer has a body defining at least one closed insulating cavity. In one embodiment, the spacer is fabricated from a foam material having a desiccant. In one embodiment, the spacer includes a plurality of insulating cavities while maintaining a structure that provides strength to the glazing unit.

### CROSS REFERENCE TO RELATED APPLICATIONS

This application is a divisional application claiming priority from U.S. patent application Ser. No. 10/613,256 filed Jul. 3, 2003, which claims priority from U.S. Provisional Application No. 60/393,593 filed Jul. 3, 2002; the disclosures of which are incorporated herein by reference.

### BACKGROUND OF THE INVENTION

1. Technical Field

This invention generally relates to insulating glazing units that may be used in windows and doors. More particularly, the present invention relates to the muntin and spacer components of insulating glazing units. Specifically, the present invention relates to the structure of the muntin and spacer components and the use of these components within insulated glazing units.

2. Background Information

Traditional windows have individual panes of glass separated by wooden muntins. While these windows are attractive and have functioned for many years, they are relatively expensive to fabricate. The expense is particularly high when a consumer desires an insulating window having spaced panes of glass sealed together by a perimeter spacer. A single window having twelve panes of glass requires twelve spacers, twenty-four panes of glass, and a precisely formed muntin grid. In addition to the cost of materials, the assembly process is also relatively expensive. Thus, although consumers desire the aesthetic properties of traditional divided lite windows, most are unwilling to pay for a true divided lite window.

Insulating windows include at least two panes of glass separated by a spacer to form a sealed cavity that provides insulating properties. These insulating windows are most efficiently manufactured with two large panes of glass separated by a single spacer disposed at the perimeter of the panes. Various solutions have been implemented to provide the divided lite appearance in insulating windows. One solution to the problem has been to place a muntin bar grid between the panes of glass. Another solution has been to place the muntin bar grid on the outer surface of one, or both, panes of glass.

A further solution is disclosed in U.S. Pat. No. 5,345,743 wherein three muntin elements are used to create a divide lite appearance. This structure uses an interior muntin bar element connected to one pane of glass and a pair of exterior muntin bar elements disposed on the outside of the glass. The exterior muntin bar elements are aligned with the interior muntin bar element to create the appearance of a traditional muntin bar.

A hollow prior art muntin bar element is disclosed in attached FIGS. 1 and 2. This prior art muntin bar element had thin exterior walls that defined a large D-shaped cavity. This large D-shaped cavity is undesirable because it causes the muntin element to collapse upon itself and slides sideways when rolled for storage. This structure thus could not be rolled in a convenient form for storage and shipping. The structure also collapsed or slid at an angle when pressed onto the interior surface of the glass sheet detracting from the aesthetics of the muntin bar.

### SUMMARY OF THE INVENTION

The invention provides a muntin bar element that is adapted to be connected to the interior surfaces of opposed glass panes to create the appearance of a traditional muntin bar. The invention provides accommodating elements that allow the muntin bar element to be connected to both interior surfaces. The accommodating elements prevent the muntin bar element from delaminating when the glazing unit expands and contracts. Various embodiments of the accommodating elements are disclosed.

The invention also provides a muntin bar element having internal openings that form insulating cavities. The insulating cavities are configured to allow the muntin bar element to maintain its structural strength so that the muntin bar element may be packaged, shipped, and installed.

The invention also provides a spacer element having an opening that increases the insulating properties of the spacer. The configuration of the opening maintains the compressive strength of the spacer. The configuration of the opening may also be used to help the spacer accommodate glazing sheet movement.

### BRIEF DESCRIPTION OF THE DRAWINGS

FIGS. 1 and 2 show a prior art D-shaped muntin bar element.

FIG. 3 is a front elevation view of a prior art simulated divided lite window having an upper and lower muntin bar grid formed with two vertical and two horizontal muntin bars.

FIG. 4 is a view similar to FIG. 3 showing a prior art window having an upper and lower muntin bar grid with each muntin bar grid being formed with two vertical and one horizontal muntin bar.

FIG. 5 is a sectional view taken along line 5-5 of FIG. 3 or FIG. 4.

FIG. 6 shows one embodiment of the invention wherein a muntin bar element 100 includes longitudinal openings.

FIGS. 7A-7E show other embodiments of the muntin bar element of the invention.

FIG. 8 is a front view of an extrusion die used to form muntin bar element 100.

FIG. 9 is a side view of FIG. 8.

FIG. 10 shows another muntin bar element having a single opening; the bar element and opening having a different cross sectional shapes than the embodiments depicted in FIGS. 7A-7E.

FIG. 11 shows another muntin bar element having a single opening; the bar element and opening having a different cross sectional shapes than the embodiment depicted in FIGS. 7A-7E.

FIG. 12 shows a cross sectional view of another muntin bar element having opposed accommodating elements before adhesive is applied to the base surfaces—the muntin bar element being formed with a height A; the body of the element being fabricated from a foam and may carry a desiccant.

FIG. 13 is a cross sectional view of the muntin bar element of FIG. 12 after adhesive is applied to the base surfaces.

FIG. 14 shows the muntin bar element applied to a first interior glass surface.

FIG. 15 shows the second glass surface being installed and pressed down against the muntin bar element to securely attach the adhesive to the glass surfaces—the muntin bar element being compressed to a thickness of B that is less than thickness A and A1; the structure of the muntin bar element preventing collapse and allowing for easy installation.

FIG. 16 shows the relaxed—or neutral pressure—position of the glazing unit wherein the muntin bar element is compressed to have a height of C that is greater than B but less than A and A1—the accommodating elements being slots that may expand when the glass sheets move apart from each other.

FIG. 17 shows an alternative embodiment of the muntin bar element having different accommodating elements—the element being slightly compressed in FIG. 17 with the glass at a neutral pressure condition; the structure of the muntin bar element preventing collapse and allowing for easy installation.

FIG. 18 shows the expanded condition of the muntin bar element of FIG. 14 such that B is greater than A.

FIG. 19 shows a cross sectional view of another muntin bar element having opposed accommodating elements before adhesive is applied to the base surfaces—the muntin bar element being formed with a height A; the body of the element being fabricated from a foam and may carry a desiccant.

FIG. 20 is a cross sectional view of the muntin bar element of FIG. 19 after adhesive is applied to the base surfaces.

FIG. 21 shows the glass sheets being installed and pressed down against the muntin bar element to securely attach the adhesive to the glass surfaces—the muntin bar element being compressed to a thickness of B that is less than thickness A and A1; the structure of the muntin bar element preventing collapse and allowing for easy installation.

FIG. 22 shows the relaxed—or neutral pressure—position of the glazing unit wherein the muntin bar element is compressed to have a height of C that is greater than B but less than A and A1—the accommodating elements being slots that may expand when the glass sheets move apart from each other.

FIG. 23 shows an alternative embodiment of the muntin bar element having different accommodating elements—the element being slightly compressed in FIG. 23 with the glass at a neutral pressure condition; the structure of the muntin bar element preventing collapse and allowing for easy installation.

FIG. 24 shows the expanded condition of the muntin bar element of FIG. 23 such that B is greater than A.

FIG. 25 shows an alternative embodiment of the muntin bar element having different accommodating elements—the element being slightly compressed in FIG. 25 with the glass at a neutral pressure condition; the structure of the muntin bar element preventing collapse and allowing for easy installation.

FIG. 26 shows the expanded condition of the muntin bar element of FIG. 26 such that B is greater than A.

FIG. 27 shows an alternative embodiment of the muntin bar element having different accommodating elements—the element being slightly compressed in FIG. 27 with the glass at a neutral pressure condition; the structure of the muntin bar element preventing collapse and allowing for easy installation.

FIG. 28 shows the expanded condition of the muntin bar element of FIG. 27 such that B is greater than A.

FIG. 29 shows an alternative embodiment of the muntin bar element having different accommodating elements—the element being slightly compressed in FIG. 29 with the glass at a neutral pressure condition; the structure of the muntin bar element preventing collapse and allowing for easy installation.

FIG. 30 shows the expanded condition of the muntin bar element of FIG. 29 such that B is greater than A.

FIG. 31 shows a spacer having an insulating cavity disposed longitudinally within the body of the spacer; the body of the spacer being fabricated from a foam material that carries a desiccant material.

FIG. 32 shows a spacer having a pair of insulating cavities disposed longitudinally within the body of the spacer; the body of the spacer being fabricated from a foam material that carries a desiccant material.

FIG. 33 shows a spacer having a pair of insulating cavities disposed longitudinally within the body of the spacer; the body of the spacer being fabricated from a foam material that carries a desiccant material.

FIG. 34 is a section view taken along line 34-34 of FIG. 30.

FIG. 35 shows a spacer having six insulating cavities disposed longitudinally within the body of the spacer; the body of the spacer being fabricated from a foam material that carries a desiccant material.

FIG. 36 is a section view taken along line 36-36 of FIG. 35.

FIG. 37 shows a spacer having spaced insulating cavities disposed longitudinally within the body of the spacer; the body of the spacer being fabricated from a foam material that carries a desiccant material.

FIG. 38 is a section view taken along line 38-38 of FIG. 37.

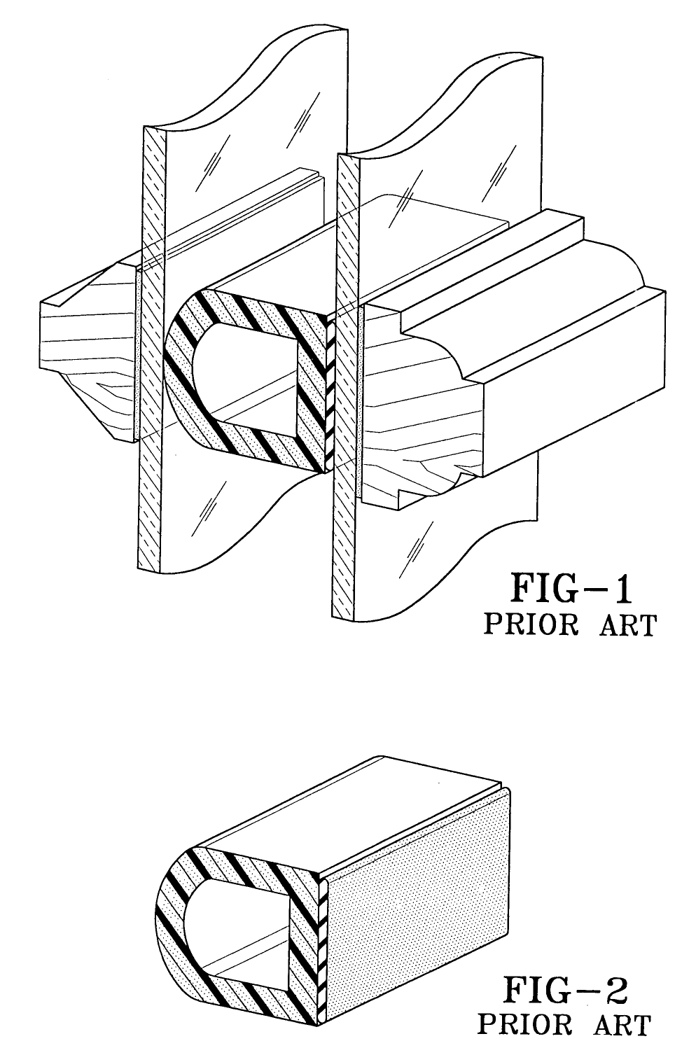

Similar numbers refer to similar parts throughout the specification.

### DESCRIPTION OF THE PREFERRED EMBODIMENTS

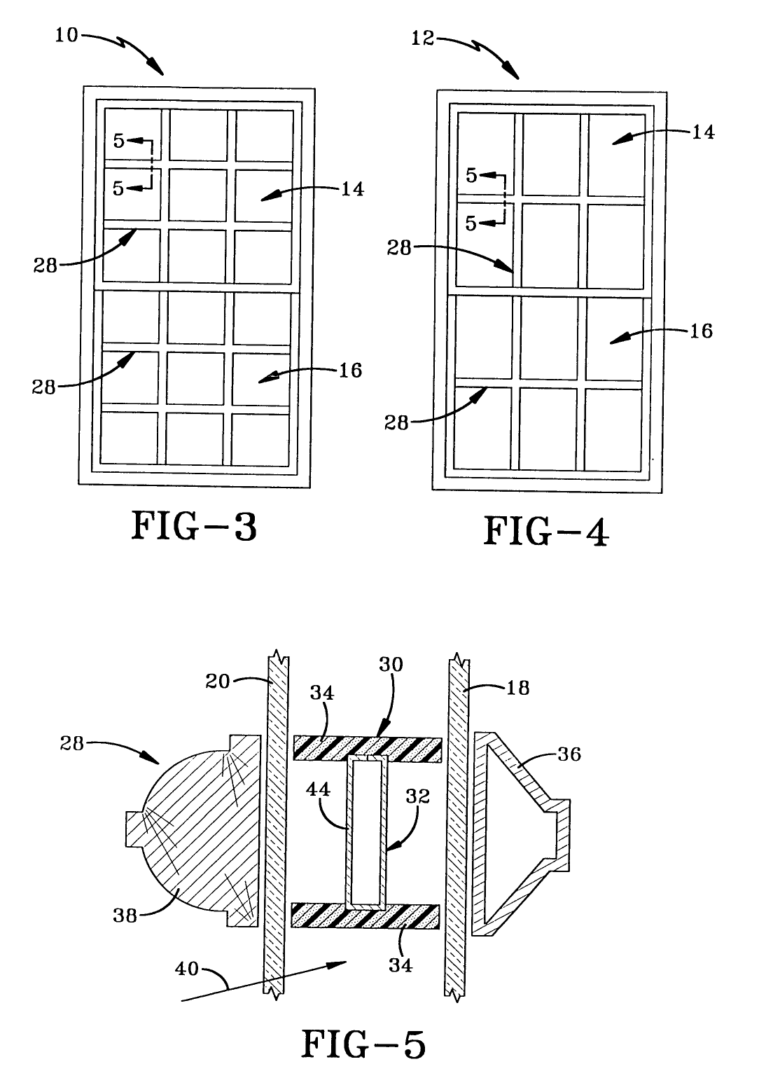

Prior art windows having simulated divided lite muntin bar grids are indicated generally by the numerals 10 and 12 in FIGS. 3 and 4, respectively. Window 10 provides an example of where insulating glazing units 14 and 16 may be used. Insulating glazing units may also be built into doors for building or appliances. Each insulating glazing unit 14 and 16 includes a pair of glass panes or sheets 18 and 20 that are spaced apart by a perimeter spacer having a desiccant matrix.

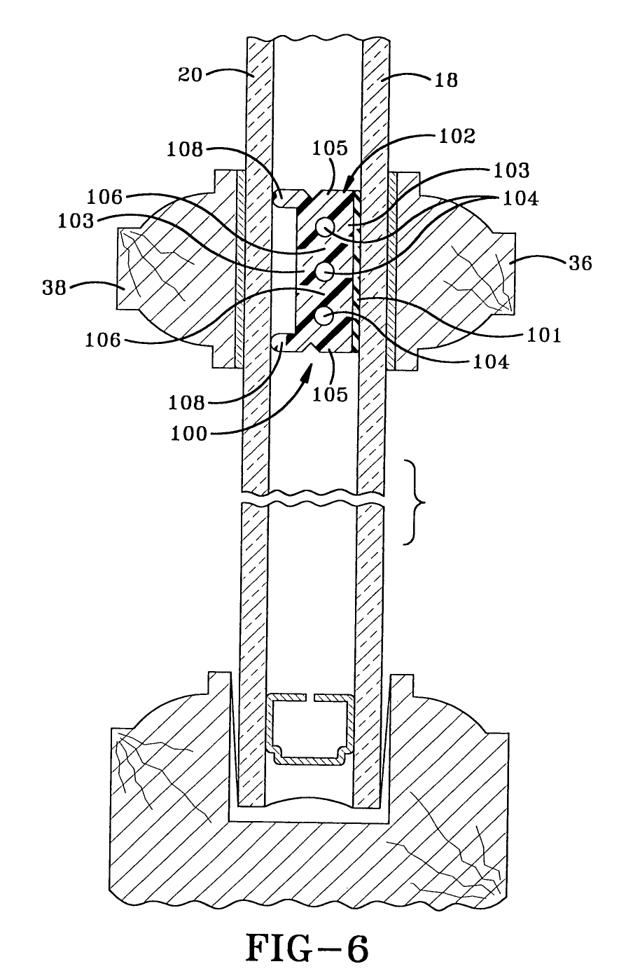

The prior art simulated divided lite muntin grid of FIG. 5 depicts an example where the internal muntin bar elements 30,32 are not attached to the interior surfaces of panes 18 or 20.

All of the different embodiments of the muntin bar elements of the invention are indicated generally by the numeral 100. Each embodiment has different characteristics that are separately described while many embodiments share features. The same numerals have been used to described common features in different embodiments where practical.

A first embodiment of an internal muntin bar element is indicated generally by the numeral 100 in FIG. 4. Muntin bar element 100 is intended to be directly attached to one of glass sheets 18 or 20 by an appropriate adhesive 101 in the manner taught in U.S. Pat. No. 5,345,743, the disclosures of which are incorporated herein by reference. Adhesive 101 may be applied to body 102 when body 102 is fabricated. Adhesive 101 is then protected with a cover that is peeled away before body 102 is attached to glass sheet 18 or 20. The protective cover also allows body 102 to be rolled for storage and shipping. In each of the embodiments described herein, body 102 is preferably fabricated from a flexible foam material such as any of those foams known to those skilled in the art of foam spacers. Body 102 may also carry a desiccant to add drying capacity to the muntin grid.

Body 102 includes a pair of spaced base walls 103 with at least one that is adapted to connect with the glass sheet 18 or 20. In some of the embodiments disclosed below, body 102 is adapted to connect with both glass sheets 18 and 20 at both base walls 103. Body 102 includes sidewalls 105 that define the height of body 102 and connect base walls 103.

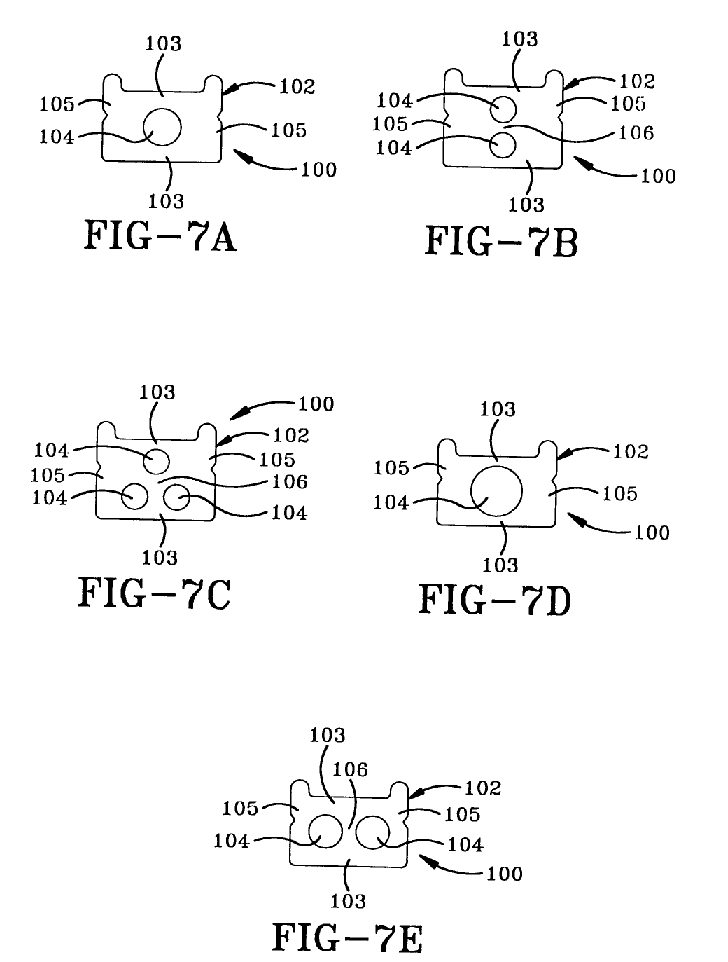

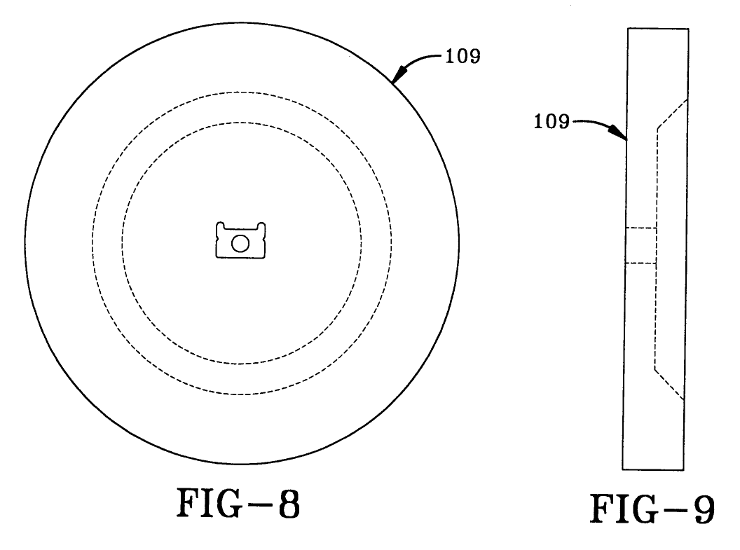

Muntin bar element 100 includes a body 102 that defines at least one insulating cavity 104. When muntin bar elements 100 touch both sheets of glass 18 and 20, they act as a thermal bridge that transfers energy across the glazing unit. Insulating cavity 104 reduce the effectiveness of the thermal bridge. Insulating cavity 104 extends longitudinally and continuously through body 102. In the embodiment depicted in FIG. 4, body 102 defines three insulating cavities 104. Each cavity 104 has a width or diameter that is equal to or less than the distance that separates one cavity 104 from another cavity 104. The intermediate body portions 106 disposed between cavities 104 provide structural support to body 102 and allow body 102 to be rolled onto itself for storage and shipping. A variety of other configurations for muntin bar elements 100 are depicted in FIGS. 7A-7E and 10-11 similar numbers are used to refer to similar parts in these drawings. In these embodiments, cavities 104 and intermediate body portions 106 are disposed in different arrangements with intermediate body portions106 preferably being larger than the widths or diameters of cavities 104. In other embodiments, cavities 104 may be wider than portions 106. FIGS. 8 and 9 depicted an exemplary extrusion die 109 that may be used to form body 102.

Body 102 is designed to be rolled for storage and shipping without causing body 102 to collapse. When the cross section of body 102 is rectangular, the longer side of the rectangle is parallel to the axis about which element 100 is rolled. Square cross sections may be rolled in either direction although the feet 108 (described below) preferably extend out the side of the roll when the cross section is square. In order to prevent the collapse of body 102 when body 102 is rolled, the cross sectional area of body 102 is preferably larger than the cross sectional area of insulating cavity 104 or the combined cross sectional areas of cavities 104. The cross sectional area of the body only includes the solid portions of body 102 and not the area occupied by the insulating cavities. This relationship between body 102 and cavity 104 allows body 102 to be rolled without significantly changing its exterior dimensions so that the roll of element 100 does not collapse sideways.

Body 102 may also include flexible feet 108 that engage the glass sheet opposite adhesive 101. Feet 108 are designed to collapse as shown in prior art U.S. Pat. No. 5,345,743 such that body 102 has expanded and collapsed conditions.

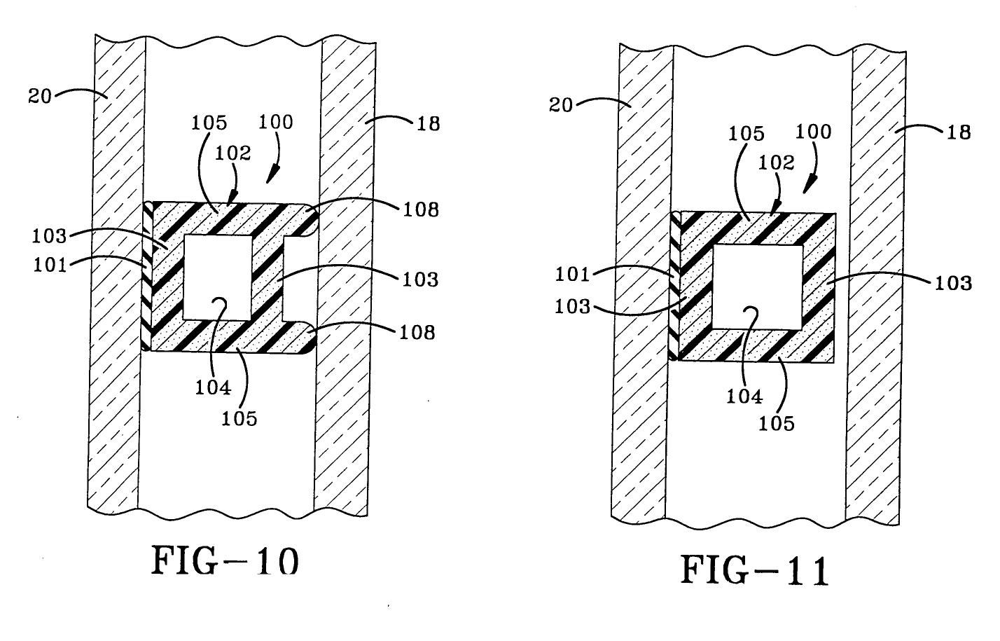

Two additional embodiments of muntin element 100 are disclosed in FIGS. 10 and 11 wherein the cross-sectional shape of the cavity is rectangular.

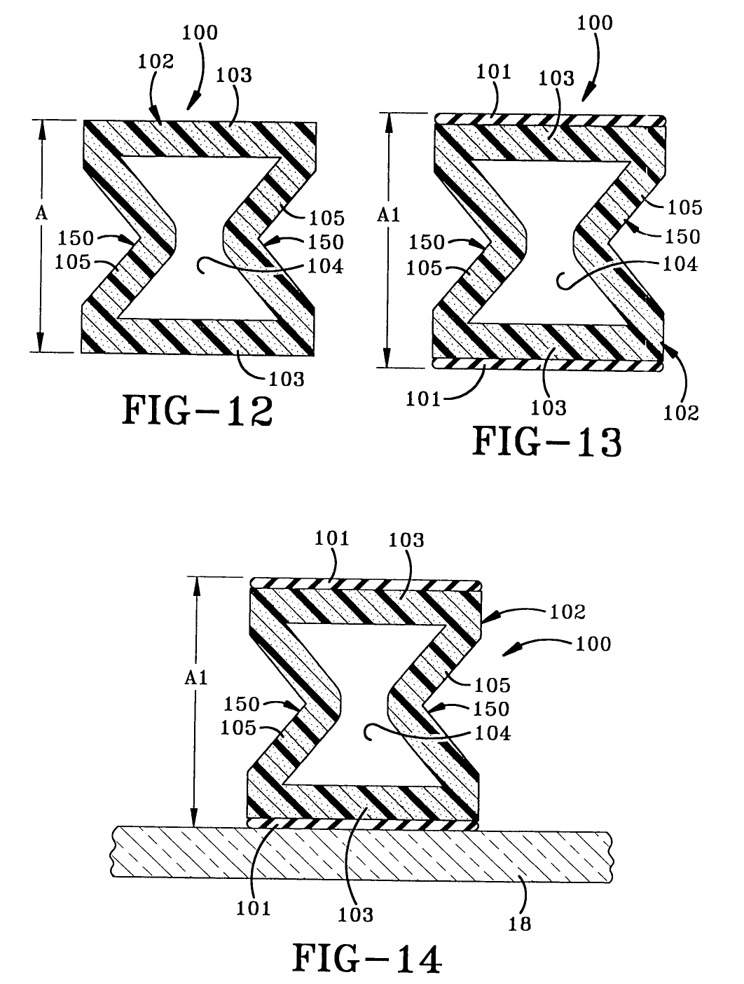

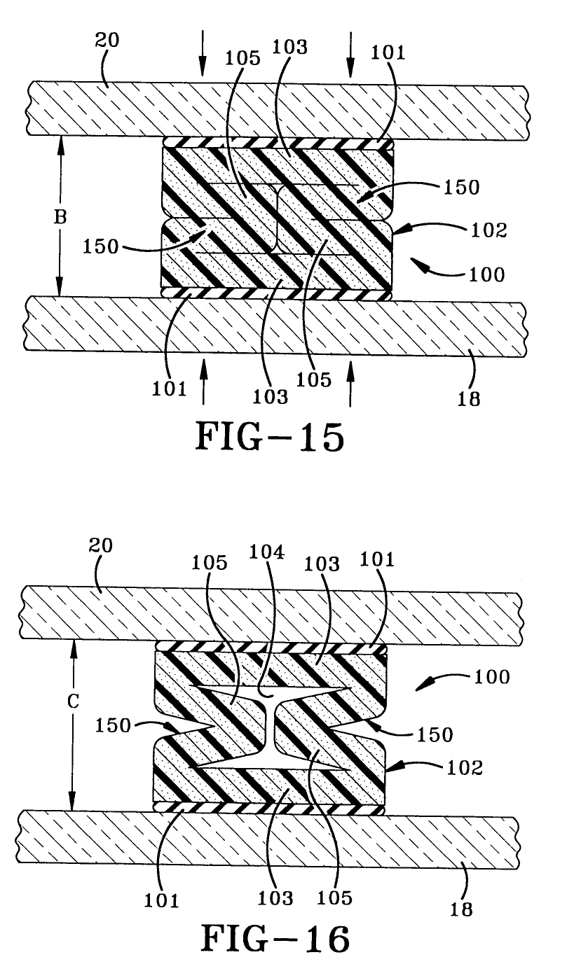

Another embodiment of internal muntin bar element 100 is depicted in FIGS. 12-16. Muntin bar element 100 is movable between collapsed (FIG. 15) and expanded (FIG. 14) positions so that it may be connected to each glass sheet 18 and 20. Glass sheets 18 and 20 will “pump” in response to pressure and temperature changes. Glass sheets 18 and 20 will also “pump” in response to gusts of wind. Sheets 18 and 20 “pump” by moving back and forth with respect to each other. This “pumping” action causes prior art muntin bar elements that are attached to both sheets 18 and 20 to delaminate from one of glass sheets 18 or 20 which ruins the appearance of the insulating glazing unit.

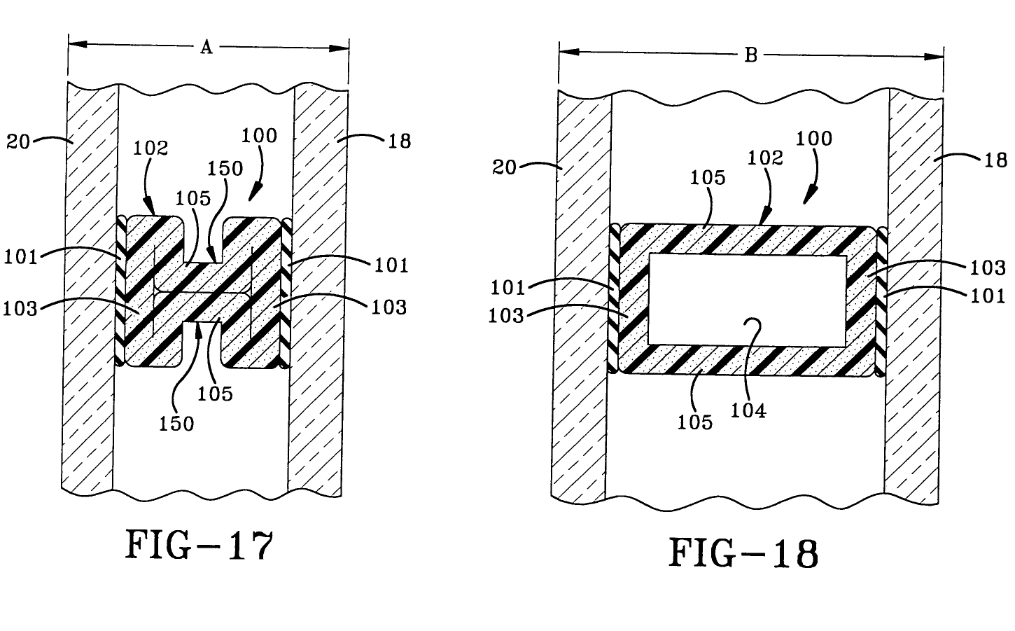

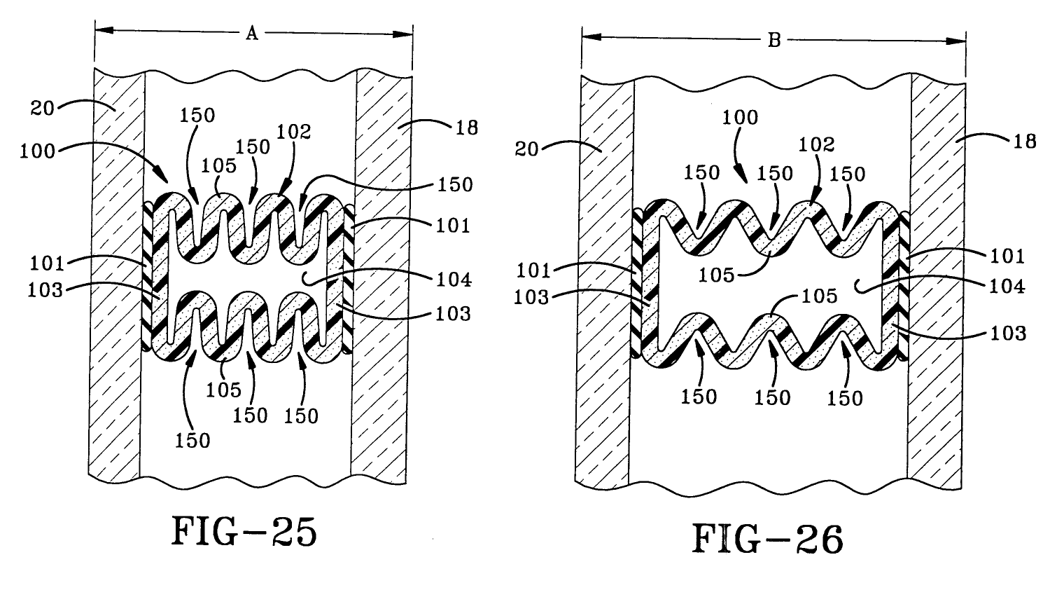

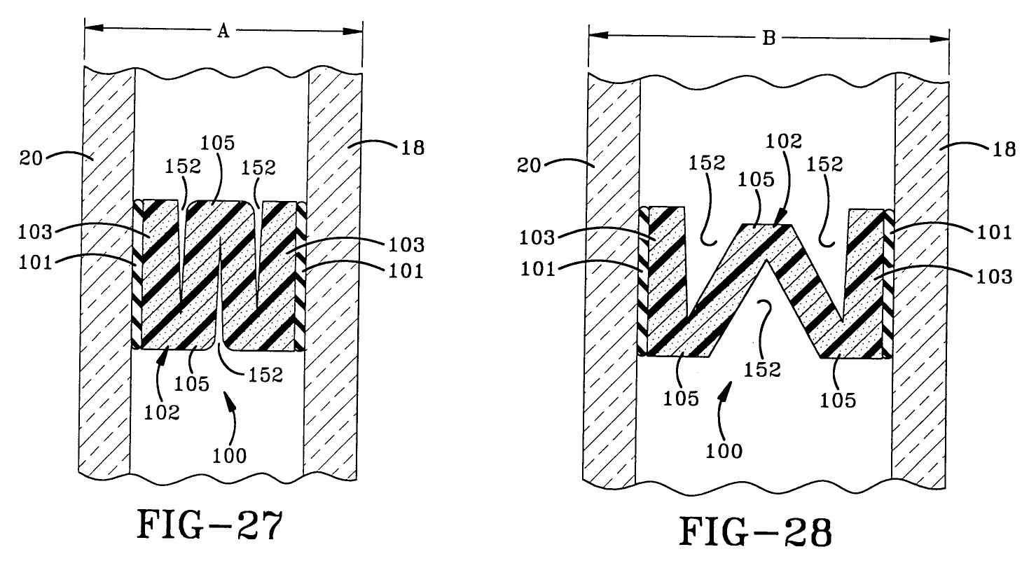

Internal muntin bar element 100 includes a pair of accommodating elements 150 that allow body 102 to accommodate the different spaces between glass sheets 18 and 20 without delaminating base walls 103 from glass sheets 18 and 20. In the embodiment of muntin bar element 100 depicted in FIGS. 12-16, accommodating elements 150 are in the form of a single corrugation defined by each sidewall 105 of body 102 or a portion of one sidewall 105 and one base wall 103. In FIGS. 12-16, the corrugation is V-shaped. In the context of this patent application, the term “corrugation” refers to a V or U shaped cross-sectional shape of sidewall 105. In the embodiment of the invention depicted in FIG. 16, accommodating element 150 is a single corrugation extending between base walls 103 in each sidewall 105. In the embodiment of FIG. 17, the accommodating element 150 is a U-shaped corrugation that has a squared inner end. In the embodiment of FIG. 22, a pair of spaced single corrugations are disposed between portions of sidewalls 105 and each base wall 103. In the embodiment of FIG. 23, each accommodating element 150 is a single rounded U-shaped corrugation. In the embodiment of FIG. 25, a plurality of corrugations define the accommodating element.

In each of the embodiments described above and shown in FIGS. 12-26, accommodating elements 150 allow the height of body 102 to automatically adjust as glass plates 18 and 20 move toward each other and apart from each other.

In the embodiment of the invention depicted in FIGS. 12-16, body 102 is formed in the shape depicted in FIG. 12 having a height of A. Body 102 may be formed by extrusion. Adhesive 101 is then added to base walls 103. The total height of body 102 with adhesive 101 is defined as A1. Adhesive 101 may also be co-extruded with body 102. Body 102 with adhesive layers 101 are then added to glass sheet 18 as depicted in FIG. 14. The user applies elements 100 in the desired muntin bar pattern. The user then applies glass sheet 20 as depicted in FIG. 15 and presses downwardly as shown by the arrows to securely attach glass sheets 18 and 20 to adhesive 101. When this pressure is applied, body 102 collapses to have a height of B and is in its fully collapsed position. FIG. 16 shows the completed glazing unit assembly (in section) with body 102 in its resting position. The resting position of body 102 has a height that is between its fully extended height and fully collapsed height so that body 102 may accommodate glass movement in either direction (toward or away from each other). The resting height of body 102 is indicated by the letter C. Dimension C is greater than dimension B but less than dimension A1.

In the embodiment of the invention depicted in FIGS. 12-16, each accommodating element 150 is designed so that the inner ends of the corrugations engage each other when body 102 is in the collapsed position as depicted in FIG. 15. This configuration also closes the outer slots of the corrugations so that body 102 may be rolled for storage in the collapsed configuration.

The embodiment of the invention depicted in FIGS. 17 and 18 show an alternative embodiment of accommodating element 150 wherein the inner surface of each corrugation abuts the other inner surface of the corrugation when body 102 is in the collapsed position as depicted in FIG. 17. As such, the collapsed position of body 102 fully closes cavity 104 as shown in FIG. 17. FIG. 18 shows the fully expanded position wherein sidewalls 105 are substantially straight and the cross section of body 102 is substantially rectangular. Each sidewall 105 is intentionally weakened at the hinges of walls 105 so that walls 105 will collapse inwardly when moved from the expanded position of FIG. 18 towards the collapsed position of FIG. 17. The weakened areas may be formed thinner than the remaining portions of wall 105. The weaken areas may also be slit to create weakened hinges. In the embodiment of FIGS. 17 and 18, dimension B is larger than dimension A.

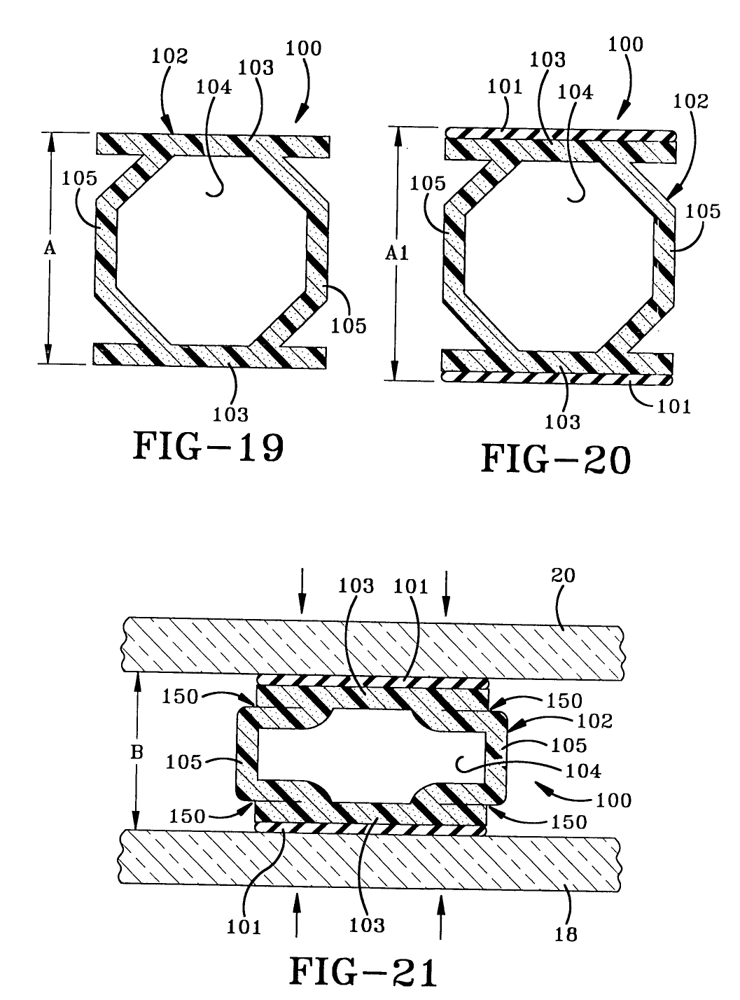

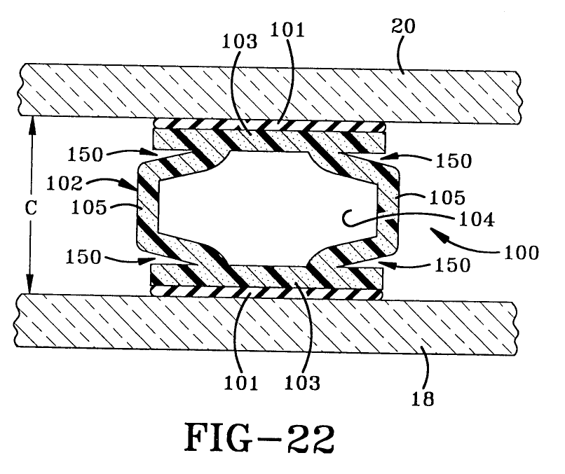

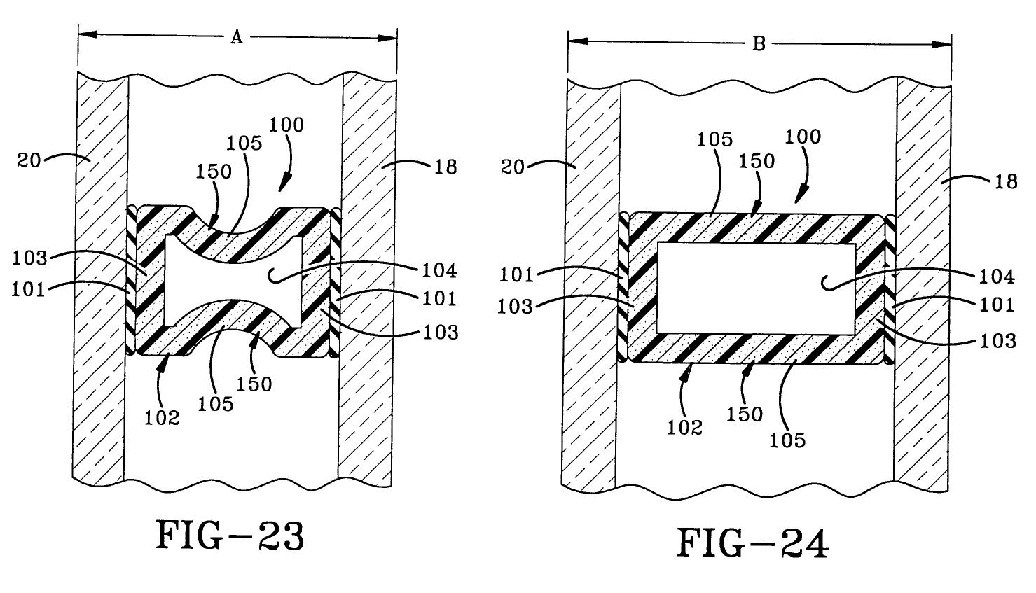

The embodiment of muntin bar element 100 depicted in FIGS. 19-22 is similar to the embodiment depicted in FIGS. 12-16 wherein the resting position of body 102 is depicted in FIG. 22 having a height of C. In this embodiment, the fully collapsed position is depicted in FIG. 21 wherein each corrugation 150 is collapsed so that body 102 has a height of B. The expanded position is not specifically shown but would have a height of at least A1. In this embodiment, each accommodating element 150 is defined by a portion of sidewall 105 and a portion of base wall 103. An intermediate portion of sidewall 105 is disposed between opposed pairs of accommodating elements 150. Body 102 has four accommodating elements 150. Body 102 is designed so that cavity 104 does not fully collapse and muntin bar element 100 retains its insulating cavity even when body 102 is in the fully collapsed position.

Another embodiment of muntin bar 100 is depicted in FIGS. 23 and 24 wherein accommodating elements 150 are U-shaped. The collapsed position is depicted FIG. 23 with the expanded position depicted in FIG. 24. In the collapsed position, walls 105 collapse inwardly but do not engage each other so that insulating cavity 104 remains open and effective. In alternative embodiments, walls 105 may collapse inwardly until they engage each other. In this condition, cavity 104 will be divided into two cavities. In the expanded position depicted in FIG. 24, accommodating elements 150 are straight and body 102 is substantially rectangular in cross-section.

In the embodiment of muntin bar element 100 depicted in FIGS. 25 and 26, accommodating elements 150 are a plurality of corrugations joined end to end. The corrugations may by U-shaped or V-shaped in this embodiment. Elements 150 are sized to retain insulating chamber 104 when in the collapsed position as depicted in FIG. 25. In this embodiment, as with the other embodiments described above, corrugations 150 may be alternatively sized to collapse against each other to form a solid section of material when body 102 is fully collapsed. FIG. 26 depicts the expanded condition of body 102 wherein each corrugation 150 is spread apart.

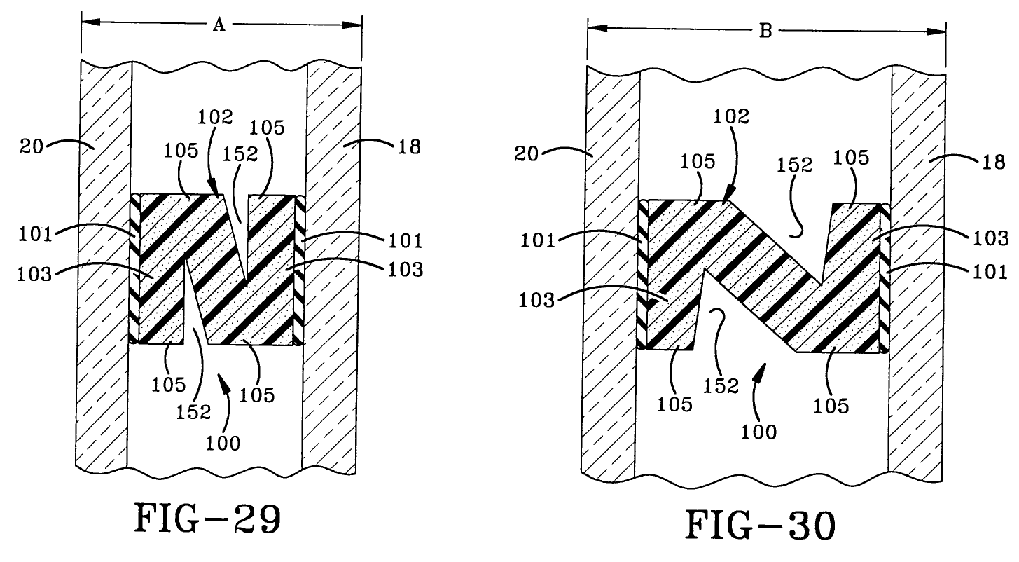

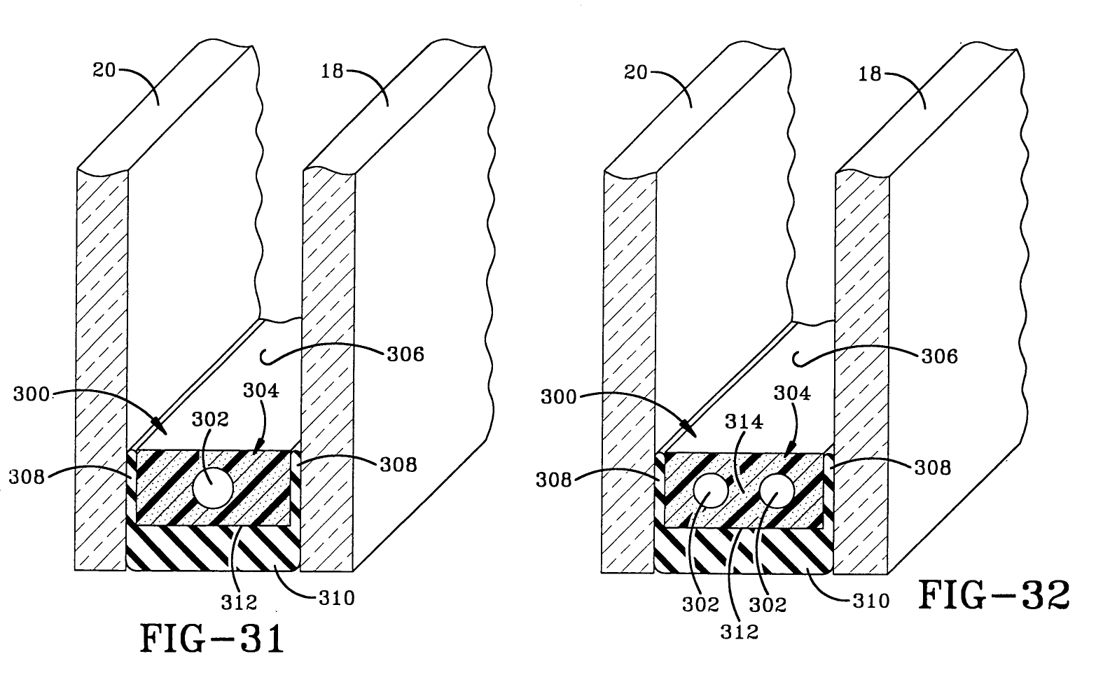

An alternative embodiment of muntin bar 100 is depicted in FIGS. 27 and 28. In this embodiment, body 102 defines slits 152 that function as the accommodating elements of body 102. Slits 152 extend inwardly from the outer surface of each sidewall 105 to allow body 102 to spread apart and accommodate distance changes between glass sheets 18 and 20 as depicted in FIG. 28. Slits 152 overlap as shown in FIGS. 27-28 such that there is no straight path through body 102 from one glass sheet 18 to the other glass sheet 20 without passing through a slit 152. In the embodiment of the invention depicted in FIGS. 27 and 28, two slits 152 extend inwardly from one sidewall 105 with a single slit 152 extending inwardly from the other sidewall 105. In the embodiment of the invention depicted in FIGS. 29 and 30, a single slit 152 extends inwardly from each sidewall 105.

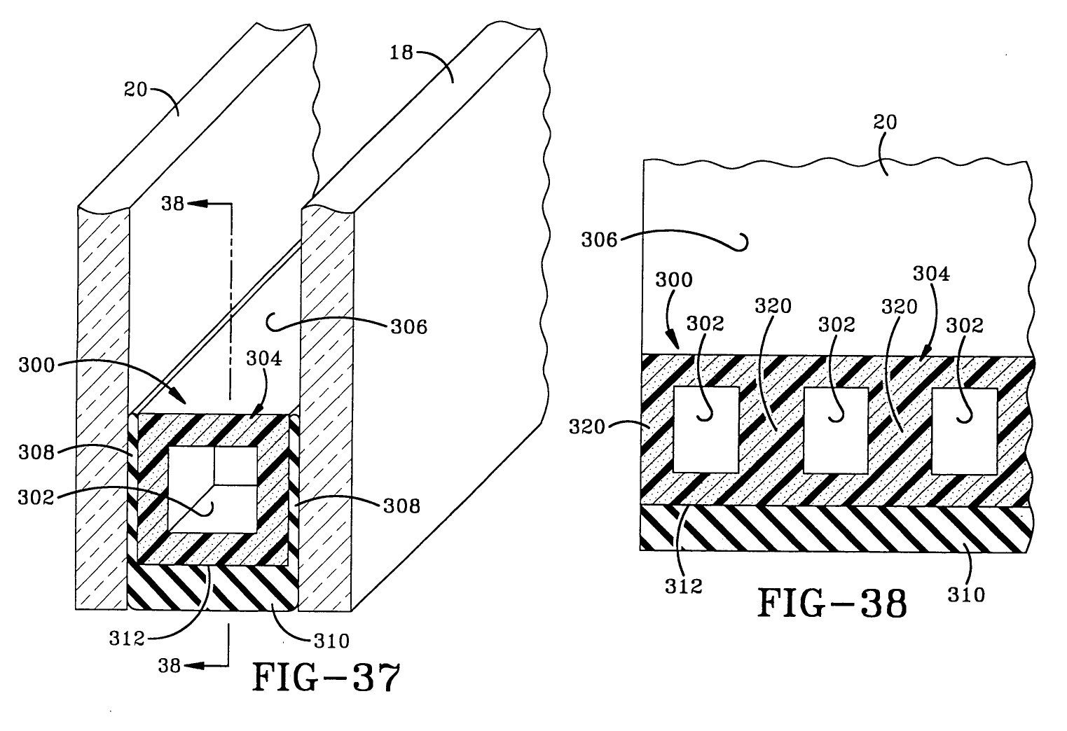

Different embodiments of the spacer of the present invention are indicated generally by the numeral 300 in FIGS. 31-38. Spacers 300 each have at least one insulating cavity 302 that is defined by the body 304 of spacer 300. As shown in the drawings, each spacer 300 is designed to be disposed slightly inwardly of the outer edge of glass sheets 18 and 20 to define a sealant channel intermediate glass sheets 18 and 20 and the outwardly facing surface 312 of spacer 300. Spacers 300 maintain an insulating cavity 306 between glass sheets 18 and 20. Each spacer 300 is connected to glass sheets 18 and 20 with an appropriate adhesive 308 and a sealant 310 that is disposed in the sealant channel. Sealant 310 prevents air from passing into or escaping from insulating cavity 306. Sealant 310 in combination with spacer 300 thus seals cavity 306 and provides an insulating property to the insulating glazing unit.

One drawback with spacers in general is that they provide a thermal bridge directly between glass sheets 18 and 20 that allow thermal energy to pass from the outside of a building to the inside of a building. Various solutions exist in the art for minimizing the negative influence of this thermal bridge. In the present invention, spacers 300 include insulating cavities 302 that are filled with air disposed at the same pressure and temperature as insulating cavity 306. Cavities 302 reduce the effectiveness of the thermal bridge and provide better insulating properties to spacer 300.

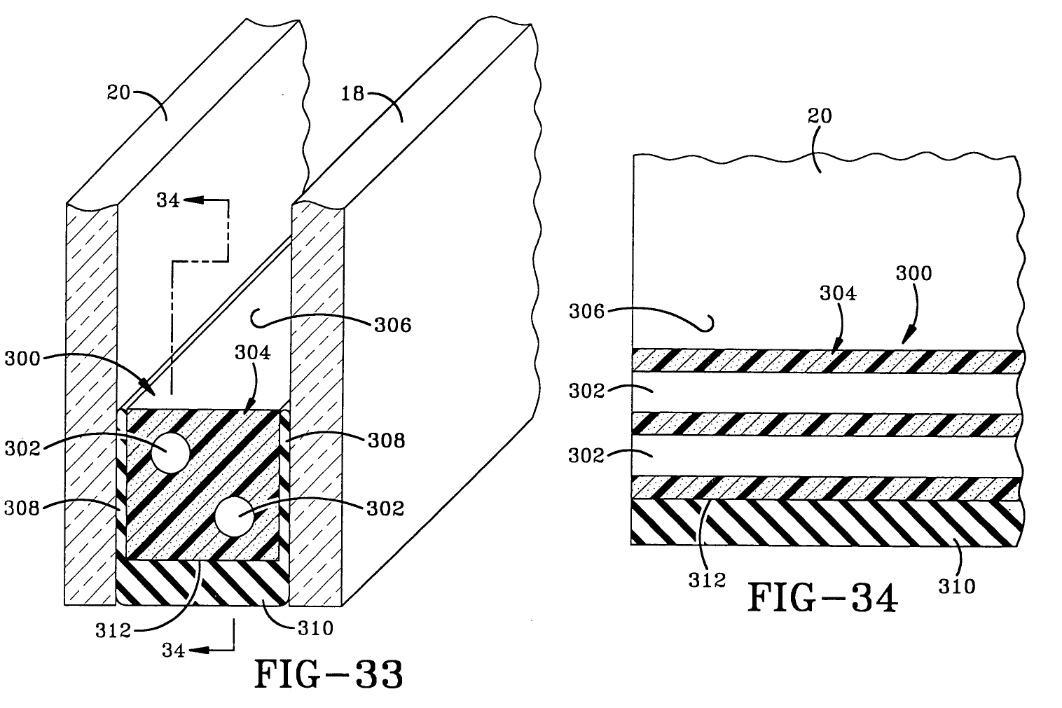

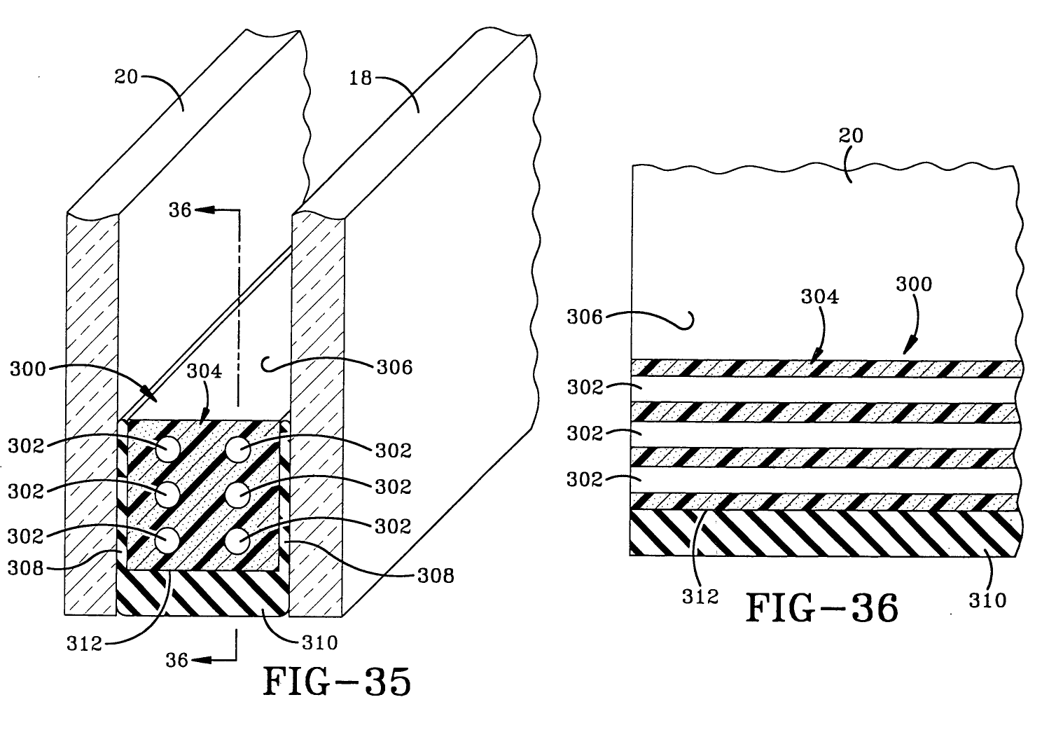

In FIG. 31, body 304 defines a single centralized insulating cavity 302 that extends continuously and longitudinally within body 304. In FIG. 32, body 304 defines a pair of spaced insulating cavities 302 that extend longitudinally and continuously within body 304. Cavities 302 are separated by an intermediate body portion 314 that has a width greater than the diameter of either cavity 302. In FIG. 33, body 304 defines a pair of insulating cavities 302 that extend continuously and longitudinally within body 304. In the embodiment of FIG. 33, cavities 302 are disposed at different heights within body 304. FIG. 35 shows an embodiment wherein body 304 defines six cavities 302 arranged in a matrix of two wide by three deep.

FIGS. 37 and 38 depict an embodiment of spacer 300 wherein insulating cavities 302 are noncontinuously disposed within body 304. Although this embodiment does not have the thermal insulating properties of the embodiments described above, it is more structurally sound because body 304 includes supports 320 that are spaced longitudinally throughout body 304.

In each of the embodiments described above, body 304 is preferably fabricated from a foam material that carries a desiccant. In each of the embodiments, a moisture/vapor barrier may be applied to the three outwardly facing sides of body 304 to help seal cavity 306.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A spacer adapted to be disposed between opposed panes of glass in a glazing unit; the spacer comprising:
a non-metal, insulating body defining at least one closed insulating cavity; the body defining opposed sides adapted to be disposed adjacent the opposed panes of glass when the perimeter spacer is disposed between the opposed panes of glass.

2. The spacer of claim 1, wherein the body defines a longitudinal direction; the insulating cavity extending in the longitudinal direction.

3. The spacer of claim 2, wherein the insulating cavity is continuous in the longitudinal direction.

4. The spacer of claim 1, wherein the body is fabricated from a foam material permeable to moisture vapor.

5. The spacer of claim 4, wherein the body includes a desiccant.

6. An insulating glazing unit using the spacer of claim 1, the unit comprising:
first and second glass sheets; each of the sheets having an outer perimeter;
the body of the spacer disposed between the first and second glass sheets inwardly from the outer perimeter to define a sealant channel outwardly of the body and an insulating chamber disposed between the body and the first and second glass sheets; and
the insulating cavity of the body being filled with a gas and the insulating chamber being filled with a gas; the gas of the insulating cavity having the same pressure as the gas in of the insulating chamber.

7. The glazing unit of claim 6, wherein the body of the spacer is fabricated from a permeable foam.

8. The glazing unit of claim 7, wherein the insulating cavity of the body is completely surrounded by the foam of the body.

9. The glazing unit of claim 8, further comprising a desiccant carried by the body of the spacer.

10. A perimeter spacer adapted to be disposed between opposed panes of glass in an insulating glazing unit; the spacer comprising:
a non-metal, insulating body defining a plurality of spaced-apart, closed insulating cavities; the body defining opposed sides adapted to be disposed adjacent the opposed panes of glass when the perimeter spacer is disposed between the opposed panes of glass.

11. The spacer of claim 10, wherein the body defines an intermediate body portion between each pair of insulating cavities; the intermediate body portion having a width; each insulating cavity has a width; the width of the intermediate body portion being equal to or greater than the width of the insulating cavities between which it is disposed.

12. The spacer of claim 10, wherein the insulating cavities are disposed at a common height within the body.

13. The spacer of claim 10, wherein the insulating cavities are disposed at different heights within the body.

14. The spacer of claim 10, wherein the body of the spacer is fabricated from a permeable foam.

15. The spacer of claim 14, wherein the insulating cavity of the body is completely surrounded by the foam of the body.

16. The spacer of claim 15, further comprising a desiccant carried by the body of the spacer.

17. The spacer of claim 10, wherein each of the insulating cavities extends continuously in the longitudinal direction.

18. The spacer of claim 10, wherein each pair of the insulating cavities is separated by a support that extends between the opposed sides of the spacer body.
